(19) United States
(12) Patent Application Publication
(10) Pub. No.: US 2009/0218171 A1
(43) Pub. Date: Sep. 3, 2009

(54) PROTECTION METHOD BY PUNCTUALLY ADDING AN ADDITIVE AND THE THEREBY PROTECTED MECHANICAL MACHINE

(76) Inventor: Christophe Nicot, Montastruc La Conseillere (FR)

Correspondence Address: ARENT FOX LLP, 1050 CONNECTICUT AVENUE, N.W., SUITE 400, WASHINGTON, DC, 20036, US

(21) Appl. No.: 12/065,324

(22) PCT Filed: Aug. 31, 2006
(86) PCT No.: PCT/FR06/02009

§ 371 Date: Jul. 9, 2008

(30) Foreign Application Priority Data
Sep. 1, 2005 (FR) 0508971

(51) Int. Cl. F16N 7/30; G06F 19/00

(52) U.S. Cl. 184/55.1; 701/51

(57) ABSTRACT

The Invention relates to a method for protecting a mechanical machine operation by punctually adding the determined quantity of at least one type of additive into said machine consisting in using an additive injection system (G1-G3) which comprises a reservoir containing a determined quantity of additive and a gas generator for expelling said additive from the reservoir to the machine and in actuating the gas generator when said machine operates at least in a critical condition. The mechanical machine provided with the system (G1-G3) for injecting said protective additive is also disclosed.

The invention relates to a method for protecting the operation of a mechanical machine as well as a mechanical machine comprising a protective additive injection system.

The invention more particularly concerns a transmission system of the motive power in a motor vehicle, such as a gear box, the protective additive then being typically a lubricant or an additive for a lubricant.

More particularly, the service life of such a machine directly depends on the quality and the quantity of the present lubricant. Now, depending on the operation time and conditions, the quality of the lubricant deteriorates (oxidation, acidification, reduction of the quantity of specific additives etc.) and the quantity tends to reduce.

In order to make the operation of a transmission system reliable, it is known to provide a new lubrication which is made either periodically, for example by emptying the system, or continuously, using a lubricant feeding device. In such a case, known devices have a constant, slow and regular flow rate with a limited life because of the utilization of batteries and have an important volume which makes their utilization impossible when the dimension constraints are important.

Besides, such embodiments do not make it possible to response to punctual conditions of critical operation which are potentially damaging for the machine, such as an overload, an overspeed and excessive temperature or an under-temperature and/or other extreme operating conditions.

In order to limit the disadvantages of such critical conditions, it is then necessary to overestimate the quantity and the quality of the lubricant with respect to those which are necessary to make the operation of the machine reliable in the standard utilization conditions. However, such solution is not optimum, neither from a technical point of view since all the critical conditions cannot be taken into consideration, nor from an economical point of view.

Besides, an additional safety lubrication device which provides the storage under pressure of a quantity of oil, so as to be able to provide for said lubrication using a connecting pipe, is known from document FR-A1-2 857 693. The implementation of such embodiment is complex and requires an additional lubrication circuit which is specific and bulky, which is not compatible with the industrial constraints, more particularly as regards the automobile field. The invention more particularly aims at solving the above-mentioned problems by providing a method for protecting the operation of a mechanical machine which offer a simple implementation and which is reliable as regards the operation in critical conditions by adding a determined quantity of an additive.

For this purpose and according to a first aspect, the invention provides a method for protecting the operation of a mechanical machine by a punctually adding a determined quantity of at least one additive into said machine, said method consisting in:
using an additive injection system which comprises a reservoir containing the determined quantity of additive and a gas generator for expelling said additive from the reservoir into the machine;
activating the gas generator when said machine operates in at least a critical condition.

According to a second aspect, the invention provides a mechanical machine comprising a casing in which the power transmission members are positioned in motion and at least one additive injection system which includes a reservoir made integral with the casing, said reservoir containing a determined quantity of an additive for protecting the operation of said machine, said system further comprising a gas generator for expelling the additive from the reservoir into the casing and a device for activating the gas generator which is so arranged as to activate said generator in case the machine operates in at least a critical condition so that, by adding the determined quantity of additive, the operation of the machine is protected.

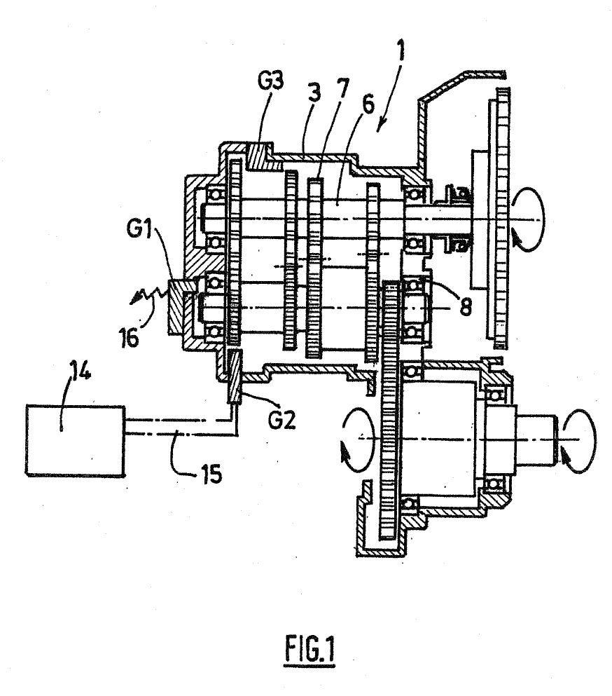

Other objects and advantages of the invention will appear more clearly while reading the following description referring to the appended drawing, in which FIG. 1 is a schematic cross-sectional illustration of a gear box of a motor vehicle with the casing of which three additive injection systems are made integral.

Above is described an embodiment of the invention relating with a gear box 1 of a motor vehicle, however the invention applies to other types of mechanical machines, more particularly those which form a system of transmission of motive power, as well as motive machines such as electric or thermal engines. Besides, the description is made while referring to an additive of the lubricant type or an additive for a lubricant without the invention being limited to such embodiments since, depending on the needs, another type of protective additive can be injected.

In mechanical machines, power transmission members are provided which are mounted in motion in a casing 3 more particularly using bearings, the whole assembly being lubricated for example with a oil introduced into said casing.

Depending on the machine, the bearing type and the application taken into consideration, the conditions of lubrication can be determined, more particularly as regards the quantity, the quality and the new lubrication frequency. Such lubrication conditions make it possible to meet a specification corresponding to a standard utilization, more particularly by anticipating several cases of exceptional operation.

According to the first aspect, the invention provides for protecting the operation of said mechanical machine in punctual conditions of critical operation which are potentially damaging for said machine, more particularly in emergency situations of the “low lubrication” type or “defective lubrication” type.

It is thus possible to limit the quantity of lubricant and its quality to those required for a standard operation while securing a protection in case of operation in exceptional or punctual conditions. It is thus further possible to consider a longer service life for the lubricant and thus a more important time interval between changes. The invention thus makes it possible to meet the technical evolution of motor vehicles (power and engine torque, vehicle aerodynamics, extension of the guarantee and maintenance times, . . . ) while complying with the legal regulations (reduction of pollution, recycling constraints, . . . ). The invention can also be implemented when combined with an additive continuous feeding system, such as those of the prior art.

According to the various embodiments, the considered operation conditions are selected in the group comprising the temperature, the rotation speed, the pressure, the torque, the composition or the quantity of a product present inside the machine, the vibration, time, the distance run in the case of a mechanical machine. Thus, the protection of the machine can be performed more particularly in case of overload, overspeed, under- or over-temperature, or times close to the limits of the specifications, in case of oil supply interruption, excessive vibration, moisture and pollution.

The protection method makes it possible to punctually add a determined quantity of at least one protective additive which is adapted for the critical condition considered. More particularly, in case the lubrication is low, adding the lubricant makes it possible to make the operation reliable and in the case of a defective lubrication, additives for lubricants exist which make it possible to readjust the lubrication to the conditions of use.

Such addition is made using an additive injection system G1-G3 which comprises a reservoir containing the determined quantity of additive and a gas generator for expelling the additive from the reservoir into the machine. The method according to the invention makes it possible to activate the gas generator in case the machine operates at least in a critical condition.

According to one embodiment, the activation of the gas generator can be notified in real time, for example using the turning on of a warning light on the driver's side and/or through the emission of an information signal to a dynamic management estimator of the vehicle. Besides, the notification can be made in concurrent operation time with the operation of the machine, so as to inform the garage mechanics that the worn out injection system needs to be replaced upon the periodical service on the machine.

According to the invention, several injection systems of a similar or a different additive can be provided, said systems being activated in case the machine operates at least in a critical condition. Such embodiment allows a reliable operation of the machine in case the same critical condition occurs several times (possibly by automatically activating the injection systems over time), or several critical conditions which require an additive of a different nature.

As a matter of fact, upon each operation of the machine in at least a critical condition, the injection of the protective additive can be activated if it is suitable. Besides, several injection devices can be simultaneously or sequentially activated in case the machine operates at least in a critical condition.

It can also be provided to combine various conditions so as to activate the injection system in case several critical thresholds are simultaneously reached or according to a predetermined sequence.

According to a first embodiment, the activation is caused by the occurrence of a critical condition. In the case where the considered operation condition is temperature, it can be provided that the reservoir contains a high temperature additive, and that the activation of the gas generator is automatically activated above a critical temperature by a control device integrated in the injection system.

According to a second embodiment, the operating condition is determined for example by means of a calculation or an estimation, then compared to a critical threshold, so as to trigger the activation of the gas generator in case the critical threshold is exceeded. As an alternative version, a delay and/or a checking that the critical threshold has been exceeded can be provided prior to the operation of the gas generator, so as to make said activation reliable by checking that the risk of damages to the machine is high.

FIG. 1 is a diagram of a gear box 1 having a conventional structure, wherein shafts 6 provided with pinions 7 are rotatingly mounted in a casing 3 using bearings 8. The casing 3 is provided with three holes in each of which is sealingly mounted a system for injecting additive G1-G3 so that the reservoir of said system can be placed in communication with the inside of the casing 3 in which the lubricant is provided.

Such embodiment is given as a description, since a different number of injection systems, having an identical or a different structure, can be provided on the gear box 1 more particularly as a function of the number and the nature of the critical operation conditions against which the box is to be protected.

Each reservoir contains a determined quantity of a protective additive of the operation of the box 1, said additive being identical or different. For example, a lubricant (first injection system G1), a high speed rotation additive (second injection system G2) and a high temperature additive (third injection system G3) can respectively be provided in a reservoir. The quantity of additive varies depending on the considered use, but it can typically be of the order of a few dozen grams.

The injection system G1-G3 further includes a gas generator for expelling the additive from the reservoir into the casing, and a device for activating the gas generator which is so arranged as to activate said generator in case the box 1 operates in at least a critical condition so that, by adding a determined quantity of additive, the operation of the box can be protected. Such injection systems are for example known from document WO-03/016724 and can more particularly be chemically, electrically activated or following a change in a physical condition.

More particularly, a standard gas generator can be provided which could be parameterized as a function of the additive and the concerned application. As an alternative, the gas generator can be provided at a distance from the additive reservoir and for example communicate with same through a pipe.

The injection systems G1, G3 are arranged in a similar way that of G1 but with a bent body, the first system G1 as the third system G3 providing an axial injection of additive, whereas the second system G2 allows a radial injection. Besides, the first system G1 is connected opposite a bearing 8, whereas the two other systems G2-G3 are connected respectively at the level of a pinion 7. Such embodiments make it possible to inject the additive close to the rotating parts, which are mainly affected by the operation in a critical condition, so as to limit the protection delay.

The gas generator includes a pyrotechnical charge and the activating device comprises means for igniting said charge. The charge is more particularly adapted to the nature and to the quantity of additive and to the desired injection kinematics. As a matter of fact, a few tenths to a few grams of pyrotechnical material can be used to obtain an injection pressure from a few bars and a few dozen bars, while the injection time can be adjusted between 1 ms and 30 s. Thanks to its modularity and its simple implementation, such embodiment is more particularly advantageous in the application considered, wherein the constraints and more particularly as regards dimensional constraints are important.

The ignition means of the second injection system G2 comprises an electrically activated primer. The activation of the gas generator is controlled by a calculator 14, for example the same as that of the vehicle engine which communicates with said primer through a wire connection 15. As an alternative, and as shown in relation with the first injection system G1, the connection can be of radio type 16. According to another embodiment, the calculator can be integrated in the injection system so as to obtain a self contained injection system.

The calculator 14 is so arranged so as to compare at least one operation condition of the machine to a critical threshold and to activate the gas generator in case said critical threshold is exceeded. For this purpose, the calculator control device can include means for measuring or estimating the operation condition. More particularly, such means can be connected to the computer so as to allow the comparison. Advantageously, it should be noted that most sensors or estimators of the operation condition are already provided in a motor vehicle such as temperature, oil pressure, oil level, motor speed, rattle, kilometer, time sensors etc.

Besides, the control device can include means for delaying and/or checking that the critical threshold has been exceeded, or means for notifying the activation of the gas generator in real time or in concurrent operation time with the operation of the machine.

In the third injection system G3, the activation is made by a mechanical means or through a change in a physical condition. In such embodiments, the operation condition is not determined, but the activation means is so arranged as to trigger above or under a threshold value of this condition.

1. A method for protecting the operation of a mechanical machine by punctually adding a determined quantity of at least one additive into said machine, said method consisting in:
using an additive injection system (G1-G3) which comprises a reservoir containing the determined quantity of additive and a gas generator for expelling said additive from the reservoir into the machine;
activating the gas generator when said machine operates in at least a critical condition.

2. A protection method according to claim 1, wherein at least an operation condition of the machine is compared to a critical threshold, the operation of the gas generator being triggered in case said critical threshold is exceeded.

3. A protection method according to claim 2, wherein the operating condition of the machine is measured or estimated.

4. A protection method according to claim 2, wherein, prior to activating the gas generator, a delay and/or a checking that the critical threshold has been exceeded is provided.

5. A protection method according to claim 1, wherein the operation condition is selected in the group comprising the temperature, the rotation speed, the pressure, the torque, the composition or the quantity of a product present inside the machine, the vibration, time, the distance run in the case of a mechanical machine.

6. A protection method according to claim 1, wherein the additive is a lubricant or an additive for lubricant.

7. A protection method according to claim 1, wherein the gas generator is of the pyrotechnical type, the activating device comprising ignition means for the generator.

8. A protection method according to claim 1, wherein the activation of the gas generator is controlled by an estimator (14) communicating with the injection system (G1-G3) through a wire connection (15) or a radio connection (16).

9. A protection method according to claim 1, wherein the injection system (G1-G3) comprises a device for controlling the activation of the gas generator.

10. A protection method according to claim 1, wherein several injection systems (G1-G3) of a similar or different additive are provided, said systems being activated in case said machine operates at least in a critical condition.

11. A protection method according to the claim 10, wherein, upon each operation of the machine at least in a critical condition, an injection system (G1-G3) of the protection additive which is suitable is activated.

12. A protection method according to the claim 10, wherein several injection devices (G1-G3) are simultaneously or sequentially activated in case the machine operates in at least a critical condition.

13. A protection method according to claim 1, wherein the activation of the gas generator is notified in real time or in concurrent operation time with the operation of the machine.

14. A mechanical machine comprising a casing (3) wherein power transmission members (6, 7, 8) are positioned in motion and at least an additive injection system (G1-G3) which includes a reservoir which is integral with the casing (3), said reservoir containing a determined quantity of an additive for protecting the operation of said machine, said system further comprising a gas generator for expelling the additive from the reservoir into the casing (3), and a device for activating the gas generator which is so arranged as to activate said generator when the machine operates at least in a critical condition so that, by adding the determined quantity of additive, the operation of the machine can be protected.

15. A mechanical machine according to claim 14, characterized in that the gas generator comprises a pyrotechnical charge, the activating device comprising means for igniting said charge.

16. A mechanical machine according to claim 14, characterized in that it includes a device for controlling the activation of the gas generator.

17. A mechanical machine according to claim 16, characterized in that the control device is integrated into the injection system (G1-G3).

18. A mechanical machine according to claim 16, characterized in that the control device includes an estimator (14) communicating with the injection system (G2-G3) through a wire connection (15) or a radio connection (16).

19. A mechanical machine according to claim 16, characterized in that the control device is so arranged as to compare at least one operation condition of the machine at a critical threshold and to activate the gas generator in case said critical threshold is exceeded.

20. A mechanical machine according to claim 19, characterized in that the control device comprises at least one of the following means:
means for measuring or estimating the operation condition;
means for delaying and/or checking that the critical threshold has been exceeded;
means for notifying the activation of the gas generator in real time or in concurrent operation time with the operation of the machine.

21. A mechanical machine according to claim 14, characterized in that the additive is a lubricant or an additive for lubricant.

22. A mechanical machine according to claim 14, characterized in that it forms a transmission system for the motive power of a motor vehicle, more particularly a gear box (1).

23. A mechanical machine according to claim 17, characterized in that the control device is so arranged as to compare at least one operation condition of the machine at a critical threshold and to activate the gas generator in case said critical threshold is exceeded.

24. A mechanical machine according to claim 18, characterized in that the control device is so arranged as to compare at least one operation condition of the machine at a critical threshold and to activate the gas generator in case said critical threshold is exceeded.

25. A mechanical machine according to claim 23, characterized in that the control device comprises at least one of the following means:
means for measuring or estimating the operation condition;
means for delaying and/or checking that the critical threshold has been exceeded;
means for notifying the activation of the gas generator in real time or in concurrent operation time with the operation of the machine.

26. A mechanical machine according to claim 24, characterized in that the control device comprises at least one of the following means:
means for measuring or estimating the operation condition;
means for delaying and/or checking that the critical threshold has been exceeded;
means for notifying the activation of the gas generator in real time or in concurrent operation time with the operation of the machine.
